(19) United States
(12) Patent Application Publication
(10) Pub. No.: US 2012/0296620 A1
(43) Pub. Date: Nov. 22, 2012

(54) DEVICE AND METHOD FOR PLANNING AN ENDOVASCULAR PROCEDURE WITH A MEDICAL INSTRUMENT

(76) Inventor: Peter Aulbach, Forchheim-Kersbach (DE)

(21) Appl. No.: 13/472,739

(22) Filed: May 16, 2012

(30) Foreign Application Priority Data
May 20, 2011 (DE) 102011076188.8

(51) Int. Cl. G06G 7/60

(52) U.S. Cl. 703/11

(57) ABSTRACT

A device and a method for planning an endovascular procedure are proposed. A medical instrument, particularly a catheter, is introduced into a vessel and is guided to its place of application via the vessel. Vessel diameters and bend radiuses along a plotted vessel course are automatically determined from the volume data set of the medical imaging and compared with a maximum diameter and minimum bend radius of the medical instrument planned for use. Points or regions within the plotted vessel course which have too low a vessel diameter or bend radius are subsequently highlighted in color in an image display of the vascular tree or vessel course. The user immediately detects critical areas and can if necessary change his or her plan or resort to an instrument with different geometric data. The method and the device make planning the endovascular procedure possible even for inexperienced users.

### CROSS REFERENCE TO RELATED APPLICATIONS

This application claims priority of German application No. 10 2011 076 188.8 filed May 20, 2011, which is incorporated by reference herein in its entirety.

### FIELD OF INVENTION

The present invention relates to a device and a method for planning an endovascular procedure, in which a medical instrument, particularly a catheter, is introduced into a vessel and guided to its place of application via the vessel.

### BACKGROUND OF INVENTION

Treatment can be carried out by endovascular means, i.e. by means of the blood vessels, for various diseases of the arteries and veins. The types of application are manifold and comprise by way of example stent graft insertion in abdominal or thoracal aortic aneurysms, in aneurysms of the arteries of the brain, in vascular stenosis of the carotid artery or the coronary arteries or in aortic/mitral valve insufficiency or minimally invasive valve replacement (e.g. TAVI). In these endovascular, minimally invasive procedures, pre-operative planning is required, which is frequently carried out by means of computed tomography (CT) or magnetic resonance tomography (MRT).

In many of the minimally invasive applications, a catheter is used, via which by way of example, stents or aortic valves are brought to the place of application. According to the type of application, the catheters have varying diameters and various catheter ends (tips). The thicker and longer the tip of a catheter is, the harder it is as a rule to achieve appropriate access to the place of use or place of application, and therefore the more rigid the catheter. A rigid, thick catheter must be carefully and cautiously navigated through the vessels. This requires precise planning of the minimally invasive intervention in order to determine a vessel course with adequate vessel diameters and curvature radiuses of the vessels which are suitable for the planned procedure and the corresponding catheter. This is often very difficult to assess, and relies on the user having great experience and knowledge.

### SUMMARY OF INVENTION

The object of the present invention is to provide a device and a method for planning an endovascular procedure with a medical instrument which enables reliable planning, even for inexperienced users.

The object is achieved with the device and the method according to the independent claims. Advantageous embodiments of the device and of the method are the subject of the dependent claims, or are disclosed by the description which follows, as well as the exemplary embodiment.

The proposed device comprises at least one visualization module which visualizes a vascular tree from a volume data set from medical imaging on a monitor, an interaction module, a determination module, and an evaluation module. The interaction module is designed so that, by means of a user interface, a user is able to plot a vessel course within the display, or to set starting and end points of a procedure, and to input a maximum diameter and minimum curvature radius of a medical instrument or information, from which the maximum diameter and minimum curvature radius of the medical instrument can be determined. The determination module determines vessel diameters and curvature radiuses of bends along the marked vessel course on the basis of the volume data set. Here, techniques known from the prior art can be used which determine these parameters, by way of example on the basis of a segmentation of the vessel course. The evaluation module then compares the maximum diameter and minimum curvature radius of the medical instrument with the diameters and curvature radiuses of the vessel course determined from the volume data set and determines vessel regions within the vessel course in which the diameter or curvature radiuses of the vessel course are smaller than the maximum diameter or minimum curvature radius of the instrument. The information about said vessel regions is transmitted to the visualization module which then highlights these regions in color in the visualization.

The determination of the vessel diameters and curvature radiuses of bends along the plotted vessel course as well as the evaluation and color coding of critical regions is automated and occurs without user intervention. This provides a considerable time advantage in the planning of minimally invasive procedures. With the aid of the color coding, the user is able immediately to see the difficult and unnavigable points in the data set or vessel course and, where applicable, to plan alternative operation paths or resort to a different catheter or a different medical instrument. Thereby, even inexperienced users can carry out complex planning of endovascular interventions. By means of the color coding of narrow points in catheter application, lower complication rates occur in subsequent interventions.

The volume data sets from medical imaging generated by means of the method and the device are preferably CT or MRT data sets. These can be a chronological sequence of 3D data sets in which by way of example various heart phases are recorded. The determination module subsequently determines the vessel diameters and curvature radiuses along the vessel course in all the data sets or recorded phases. The evaluation module is embodied such that in such multi-phase volume data sets, it uses the smallest vessel diameter and smallest bend radius respectively for each point in the vessel course for the comparison. In this manner it is taken into account that the vessel diameter or the curvature radius in a certain heart phase may possibly be too low for the use of a certain instrument or catheter. By taking into account the complex movements of the heart and the vasculature connected thereto with their effects on the diameters and curvature radiuses, the complication rates in the planned intervention can again be reduced.

The proposed device preferably also comprises a planning module which, from the starting and end points within the vascular tree which are set by the user in the display of the vascular tree, determines a vessel course with the shortest path between starting and end point and plots a vessel course for further evaluation. In this manner, the user can plot the access point for the instrument into a vessel and the target of the instrument for the planned application and automatically identifies the shortest path between these two points through the vessels.

Using the proposed device and the corresponding method, the user can also even plot the vessels through which he or she wishes to guide the instrument in the display, in one click. A further possibility is to click on each individual point in the vascular tree which plots the vessel course.

Inputting the information about the maximum thickness of the instrument (corresponding to the thickest point of the part of the instrument to be introduced) and correspondingly about the minimum curvature radius which the introduced part of the instrument allows, can for example result directly via the input of this data. In another advantageous embodiment, the user enters only the description of the instrument, through which said instrument can be uniquely identified. The device in this case connected to a database or comprises such a database, in which, for every instrument or catheter description, the corresponding maximum diameters and minimum curvature radiuses are given. The evaluation module reads this data from said database for the comparison which is to be carried out.

### BRIEF DESCRIPTION OF THE DRAWINGS

The proposed method and the corresponding device are again briefly described in the following with the aid of an exemplary embodiment in connection with the drawings, in which:

FIG. 1 schematically shows an example for a configuration of the proposed device, and

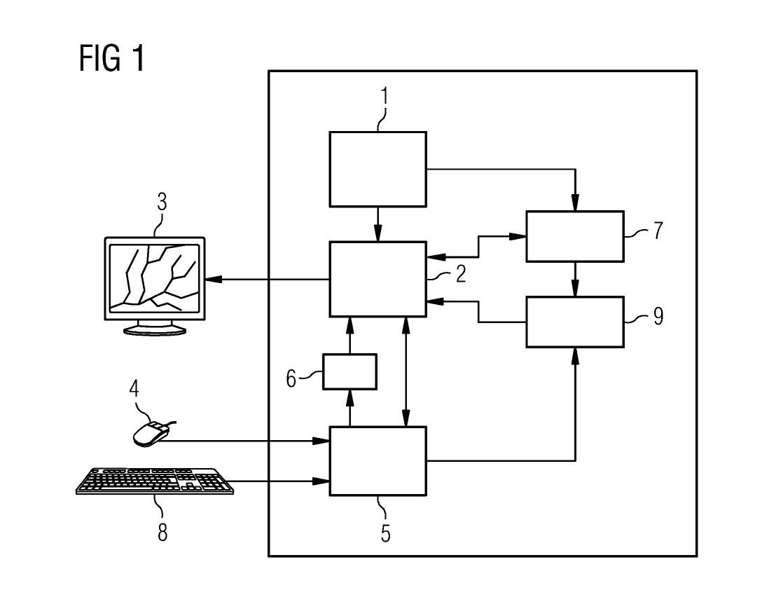

FIG. 2 shows an example for the method steps in carrying out the proposed method.

### DETAILED DESCRIPTION OF INVENTION

The proposed device and the corresponding method are described in the following using the example of planning for the use of a TAVI catheter. TAVI catheters are approx. 7 mm thick and require relatively large bend radiuses of the vessels involved due to their rigidity. For the planning, a CT-angiographic data set was described, which leads from the groin to the aortic arch. In the proposed device, said volume data set is stored in a data memory 1. The data set with clearly marked up vessels on the basis of the angiography are presented to the user via a visualization module 2 on a monitor 3. The user can select the vessels on the monitor through which the path of the catheter should later run. As a rule, this occurs with the aid of a graphic input device, by way of example, a mouse 4, via an interaction module 5. Thereby, the vessels can by way of example be selected in the known manner with a mouse click.

In an advantageous embodiment the user can also set a starting point on the monitor (e.g. access via groin, femoralis) and an end point (aortic valve). A planning module 6 automatically determines therefrom a coherent path within the vascular tree which presents the shortest connection between starting and end point. Subsequently, the vessel diameter at each point of the plotted vessel course is calculated along this determined center line in the determination module 7. Suitable methods are already known from the prior art herefor.

If the vessels are not yet automatically found, the individual vessel segments are—as is usual today—clicked into in the image display using the graphic input device. Manual center lines are thereby formed which are aligned. Subsequently, as already described above, the determination of the vessel diameters and curvature radiuses of bends are again carried out in the determination module 7.

Known methods from the prior art for determining the vessel diameters along a center line are used by way of example in the field of vessel wall detection and stenoses measurement. After the plotting of the desired or determined vessel course and the determination of the vessel diameters and curvature radiuses of the bends in said vessel course, the user can input the maximum diameter and minimum bend radius for the use of the planned catheter via the interaction module 5, by way of example via a keyboard 8. An evaluation module 9 compares this data with the data determined in the vessel course and determined points in the vessel course where the vessel diameter is smaller than the maximum diameter of the catheter and regions which have a smaller bend radius than the minimum bend radius of the catheter. The determined points or regions are transmitted to the visualization module 2 which visualizes the corresponding points or vessel regions with a color overlay in the image display in order to warn the user about vessel radiuses which are too small or too sharp.

In an advantageous embodiment, the device is connected with a database which comprises geometric catheter information relating to the respective catheters. By inputting a certain catheter or catheter type, the device then accesses said database in order to transfer the required data about the catheter i.e. its main dimensions, in particular thickness, as well as its minimum bend radius and use this for the comparison.

The result of planning with the proposed method or the proposed device with the aid of the diameters and bend radius data is an image display of a CT or MRT angiography data set with color coding. The red color here can signal e.g. a diameter which is too small or a vessel radius which is too narrow. Yellow can be used for the intermediate region. The free region, i.e. the vessel region which can be passed by the catheter with no risk can be left without coloring. Vessel narrow points such as stenoses or plaques are also taken into consideration here. Today, these are already determined or the free vessel lumens quantified very effectively with known vessel wall segmentation algorithms or by means of CT dual energy direct angiography.

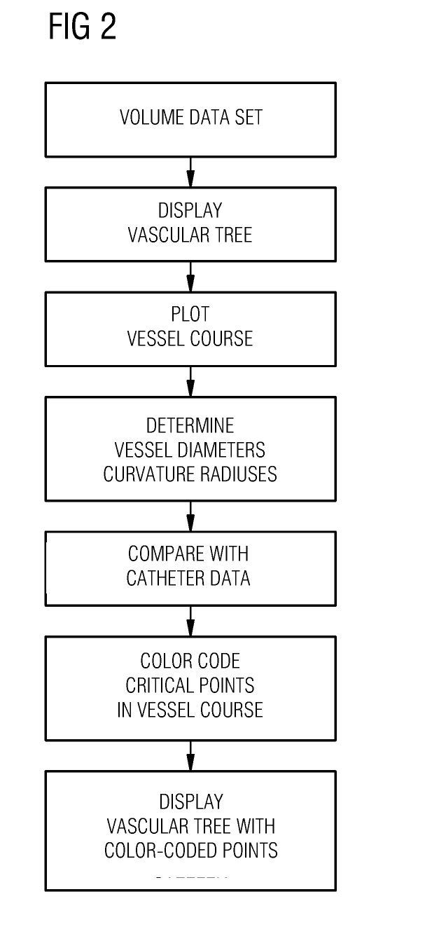

The method steps described here of the proposed method are once again shown schematically in FIG. 2.

In a further advantageous development of the method, the movement of the vessels is taken into account in multi-phase data sets. Such data sets are, as a rule, recorded by means of EKG coupling. The complex movement of the ascending aorta can also be taken into consideration here. Thus, by way of example, in a determined heart phase, a curvature radius or a diameter can be too small. This is taken into consideration in the evaluation of said data sets with the proposed method or the proposed device.

With the aid of the color coding, the user can immediately see the difficult and unnavigable points in the vessel course or vascular tree of the data set and if necessary plan different operation paths or resort to a different catheter.

1. A device for planning an endovascular procedure, comprising:
a visualization module that visualizes a vascular tree on a monitor from a volume data set of medical imaging;
an interaction module that enables a user by a user graphic interface to plot a vessel course on the monitor and to input a maximum diameter and minimum curvature radius of a medical instrument that is introduced into a vessel and is guided to a place of application via the vessel ;
a determination module that determines vessel diameters and curvature radiuses of the vessel course along the plotted vessel course from the volume data set;
an evaluation module that compares the maximum diameter and minimum curvature radius of the medical instrument with the determined vessel diameters and curvature radiuses of the vessel course, and determines and transmits a vessel region within the vessel course in which a diameter or curvature radius of the vessel course is smaller than the maximum diameter or minimum curvature radius of the medical instrument to the visualization module,
wherein the visualization module highlights the transmitted vessel region in color for visualization.

2. The device as claimed in claim 1, further comprising a planning module that determines and plots a vessel course with a shortest path between a starting point and an end point of the procedure in the vascular tree set by the user.

3. The device as claimed in claim 1, wherein the interaction module enables the user to set points for a center line of the medical image by segmenting the vessel, and to plot the vessel course obtained thereby.

4. The device as claimed in claim 1, wherein the interaction module inputs information of the medical instrument from which the maximum diameter and minimum curvature radius of the medical instrument can be determined.

5. The device as claimed in claim 4, wherein the information comprises a description of the medical instrument that the interaction module can calls up the maximum diameter and minimum curvature radius of the medical instrument from a database.

6. The device as claimed in claim 1, wherein the determination module detects a reduction in a vessel diameter due to plaques or stenoses and determines the vessel diameters and curvature radiuses of the vessel course according to the reduction.

7. The device as claimed in claim 1, wherein the determination module determines vessel diameters and curvature radiuses along the vessel course in all recorded phases of a multi-phase volume data sets, and wherein the evaluation module compares the maximum diameter and minimum curvature radius of the medical instrument with a smallest vessel diameter and a smallest curvature radius along the vessel course in the all recorded phases of the multi-phase volume data sets.

8. The device as claimed in claim 1, wherein the medical instrument is a catheter.

9. A method for planning an endovascular procedure, comprising:
visualizing a vascular tree on a monitor from a volume data set of a medical imaging;
plotting a vessel course on the monitor by a user via a user graphic interface;
inputting a maximum diameter and minimum curvature radius of a medical instrument that is introduced into a vessel and is guided to a place of application via the vessel by the user;
determining vessel diameters and curvature radiuses of vessel course along the plotted vessel course from the volume data set;
comparing the maximum diameter and minimum curvature radius of the medical instrument with the determined diameters and curvature radiuses of the vessel course;
determining a vessel region within the vessel course in which a diameter or curvature radius of the vessel course is smaller than the maximum diameter or minimum curvature radius of the medical instrument based on the comparison; and highlighting the determined vessel region in color for visualization.

10. The method as claimed in claim 9, further comprising determining a vessel course with a shortest path between a starting point and an end point of the procedure in the vascular tree set by the user.

11. The method as claimed in claim 9, further comprising detecting a reduction in a vessel diameter due to plaques or stenoses to be considered in the determination of the vessel diameters.

12. The method as claimed in claim 9, further comprising determining vessel diameters and curvature radiuses along the vessel course in all recorded phases of a multi-phase volume data sets, and comparing the maximum diameter and minimum curvature radius of the medical instrument with a smallest vessel diameter and a smallest curvature radius along the vessel course in the all recorded phases of the multi-phase volume data sets.

13. The method as claimed in claim 9, wherein the user inputs information from which the maximum diameter and minimum curvature radius of the medical instrument can be determined.
